(19) United States
(12) Patent Application Publication
(10) Pub. No.: US 2005/0272417 A1
(43) Pub. Date: Dec. 8, 2005

(54) Handheld electronic device and method for firmware upgrade

(75) Inventor: Cheng Liu, Dong-Guan (CN)

Correspondence Address: RADER FISHMAN & GRAUER PLLC, LION BUILDING, 1233 20TH STREET N.W., SUITE 501, WASHINGTON, DC, 20036, US

(73) Assignee: Asia Optical Co., Inc.

(21) Appl. No.: 11/128,249

(22) Filed: May 13, 2005

(30) Foreign Application Priority Data
May 13, 2004 (TW) 93113440

(51) Int. Cl. H04Q 7/00; H04M 3/00; G06K 7/10; G06K 9/22

(52) U.S. Cl. 455/419; 455/418

(57) ABSTRACT

A handheld electronic device and its method for firmware upgrade are provided. More specifically, it's a mobile phone and the method for upgrading its firmware. The present invention includes a transmitter for receiving an upgrade program that includes an upgrade check code and a new source code from a wireless base station, a storage unit for storing the new source code and a basic control code, and a processing unit for verifying the upgrade check code, and controlling the firmware upgrade based on the basic control code. The method of the present invention is a method for upgrading a handheld electronic device by receiving the upgrade program via a wireless connection. Based on the basic control code, automatic or manual firmware upgrade is performed.

### CROSS-REFERENCE TO RELATED APPLICATIONS

This Application claims the right of priority based on Taiwan Patent Application No. 093113440 filed on May 13, 2004, which is incorporated herein by reference.

### FIELD OF THE INVENTION

The present invention relates to a handheld electronic device and a method for firmware upgrade thereof. In particular, the present invention relates to a mobile communication device and a method for firmware upgrading of the handheld electronic device by connecting to a base station via a mobile telecommunication network.

### BACKGROUND OF THE INVENTION

For a conventional handheld electronic device, such as a PDA or a handheld communication device, the firmware for operating the device is stored in the memory of the device. However, in order to satisfy the market needs to have the handheld electronic device provide a variety of functionalities, the firmware in the handheld electronic device needs to be upgraded from time to time.

A conventional handheld electronic device comprises a processing unit, a memory, a firmware, and a communication port; wherein the firmware is stored in the memory, and the handheld electronic device is operable through a program code provided by the firmware.

Different from that of a conventional computer, the memory of the conventional handheld electronic device can only store a limited amount of programming software. Additionally, the conventional handheld electronic device does not have any peripheral hardware for reading the software stored in different memory media. Thus, the manufacturer of the handheld electronic device usually writes the firmware directly in the memory. The firmware being written in the memory needs to be replaced through a special tool in the manufacturing factory, otherwise it cannot be modified. Thus, a conventional method is to return the handheld electronic device back to the original manufacturer. The manufacturer will use a special tool to upgrade the firmware. However, the conventional method for firmware upgrade not only incurs a high cost, but also causes inconvenience to the user.

Furthermore, when the manufacturer is developing new functionalities for the handheld electronic device, the utility and workability of the new functionalities need to be verified by the continuous usage from the user's end. Instability of the handheld electronic device occurs during the testing phase of the new functionalities. Such instability needs to be solved by a multiplicity of debugging mechanisms. Therefore, repeatedly returning the handheld electronic device in the experimenting phase to the original manufacturer is a time wasting and high cost generating process.

In addition, in order to enhance the competitiveness and thus ensure market share, the manufacturer of the handheld electronic device is developing cutting-edge functionalities more frequently and efficiently. Thus, the conventional method for firmware upgrade of the handheld electronic device is no longer appropriate.

In order to overcome the disadvantages of the conventional method, namely time wasting and inefficiency, the present invention intends to provide an efficient device and method for upgrading the firmware in the handheld electronic device by upgrading the firmware through a wireless transmission from a base station that is connecting to the a mobile telecommunication network such that the firmware within a receivable range of the handheld electronic device can be upgraded.

### SUMMARY OF THE INVENTION

One aspect of the present invention is to provide a device and a method for upgrading the firmware of the handheld electronic device through a base station connecting to a mobile telecommunication network.

The present invention can overcome the disadvantages of the prior art mentioned above, namely time wasting and inefficiency.

Another aspect of the present invention is to maintain the latest version of the firmware in the user's handheld electronic device so as to fully utilize the functionalities provided by the handheld electronic device.

The handheld electronic device of the present invention is connected to a base station via a mobile telecommunication network. The base station upgrades the firmware of the handheld electronic device via a wireless transmission. The handheld electronic device includes a transmitter for receiving an upgrade program that has an upgrade check code and a new source code from the base station, a storage unit for storing the new source code and a basic control code needed for controlling an upgrade operation of the handheld electronic device, and a processing unit for automatically or manually replacing the original source code with the new source code received based on the basic control code and for storing it in the firmware of the handheld electronic device; wherein the basic control code is permanently stored in the storage unit, and does not change with the upgrade of the source code such that the handheld electronic device can still proceed to receive and recover the source code when an abnormal situation occurs during the upgrading process.

The handheld electronic device of the present invention further includes a display unit for inquiring a user whether to execute the upgrade, an input unit allowing a user to input whether to execute the upgrade, and a temporary memory unit for temporarily backing up the original source code when the handheld electronic device is being upgraded.

The firmware upgrade method of the present invention is to upgrade the firmware in the handheld electronic device through a wireless transmission from a base station. The method includes wirelessly receiving an upgrade program from the base station, and automatically or manually executing the upgrade, based on the upgrade program; wherein the upgrade program includes an upgrade control code and a new source code. A storage unit of the handheld electronic device provided in accordance with the method of the present invention stores a basic control code and a source code. Furthermore, the handheld electronic device further includes a temporary memory unit such that the upgrading step in accordance with the method of the present invention further includes copying the original source code to the temporary memory unit, erasing the original source code in the storage unit, and copying the new source code to the storage unit.

The firmware upgrade method of the present invention further includes transmitting a data to the base station. When the data is an upgrade failure data, the original source code stored in the temporary memory unit is coped back to the storage unit.

### BRIEF DESCRIPTION OF THE DRAWINGS

FIG. 1 is a schematic view of a preferred embodiment of the present invention; and

FIG. 2 is a flow chart of the present invention.

### DETAILED DESCRIPTION

The handheld electronic device of the present invention can be a mobile communication device, a personal digital assistant (PDA), or any device that can provide similar functions. Preferably, the present invention is a mobile phone.

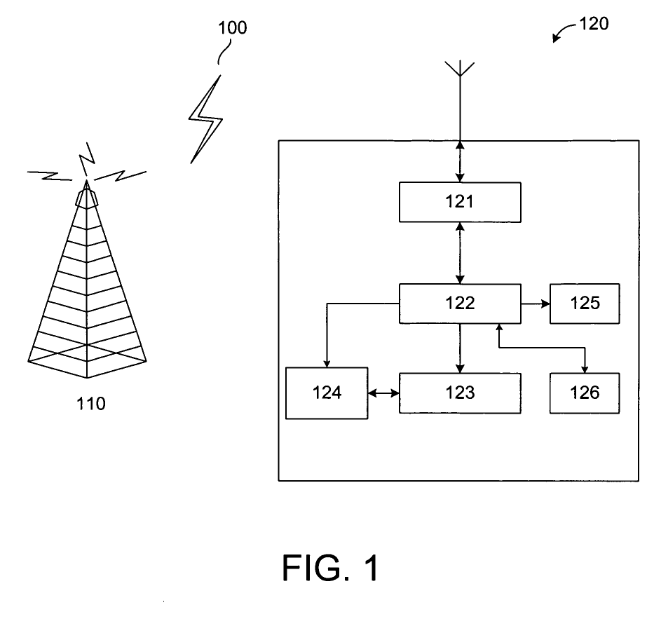

Referring to FIG. 1, the embodiment provides a connection to a base station 110 via a mobile telecommunication network 100. The base station 110 wirelessly transmits a message to the handheld electronic device 120 via the mobile telecommunication network 100. For example, a mobile phone user can utilize the wireless transmission function of the base station 110 to send simple messages to other mobile phone users. The manufacturers of the mobile phones can also utilize the wireless transmission function to send a firmware upgrade message to the mobile phone. The firmware is for operating the functions of the mobile phone.

In one embodiment of the present invention, the handheld electronic device 120 includes a transmitter 121, a processing unit 122, a storage unit 123, and a temporary memory unit 124. The transmitter 121 can receive an upgrade program from the base station 110. The upgrade program includes an upgrade check code and a new source code. After the upgrade check code is verified by the processing unit 122, the original source code originally stored in the processing unit 122 is temporarily stored to the temporary memory unit 124, and then the new source code received is stored in the storage unit 123.

The transmitter 121 of the handheld electronic device 120 can be any transmitter capable of receiving a wireless signal. The function of the transmitter 121 is to receive a message from the base station 110. For example, the message can include a simple text message, and a multimedia message between mobile phone users of the same kind, as well as other similar messages between mobile phones compatible with different kinds. The transmitter 121 in the present invention receives the upgrade program sent to the mobile phone from the manufacturer through the base station 110; wherein, the upgrade program includes an upgrade check code and a new source code for upgrading the firmware of the mobile phone so as to enhance the functionalities of the mobile phone.

The transmitter 121 can also return an upgrade data back to the mobile phone manufacturer via the base station 110 so as to notify the manufacturer whether the firmware upgrade is complete. The mobile phone manufacturer can use this returned upgrade data to ensure the quality of the upgrade. The upgrade data can be data of successful upgrade or failure upgrade.

The processing unit 122 of the present invention is responsible for controlling the handheld electronic device 120. The processing unit 122 can facilitate the interconnection among the elements so as to allow a normal operation for the handheld electronic device 120. For example, the processing unit 122 can connect to the transmitter 121, the temporary memory unit 124, and the storage unit 123 respectively. After the verification that the upgrade program has been received, the processing unit 122 stores the original source code originally stored in the storage unit 123 to the temporary memory unit 124 by reading the basic control code stored permanently in the storage unit 123, and meanwhile the storage unit 123 is erased so as to store the new source code to the storage unit 123.

The function of the processing unit 122 in one embodiment in accordance to the present invention is to identify the message received by the handheld electronic device 120 and to detect the status of the handheld electronic device 120. The status of the handheld electronic device 120 can be power off or power on, where the power on status can further be divided into in use or standby. Preferably, the present invention is adopted in a standby status of the handheld electronic device 120. When the processing unit 122 identifies that the message received by the handheld electronic device 120 includes an upgrade check code, the data received is recognized as an upgrade program, and when the processing unit 122 identifies the status of the handheld electronic device 120 as in standby, the processing unit 122 automatically executes the new source code in the upgrade program to upgrade the firmware of the handheld electronic device 120 according to the basic control code.

The storage unit 123 of the present invention 120 is installed in the handheld electronic device 120. It belongs to a firmware and is used for operating the source code required by the handheld electronic device 120. Additionally, the storage unit 123 is responsible for permanently storing a basic control code so as to control the upgrade operation of the handheld electronic device 120. For example, in order to upgrade the functionalities of the mobile phone 120, the manufacturer can send the upgrade program for the mobile phone 120 to the mobile phone 120 via the base station 110 such that the storage unit 123 can store the upgrade program. In one embodiment of the present invention, the storage unit 123 can be an SRAM or a Flash memory.

The temporary memory unit 124 of the handheld electronic device 120 can also be installed in the handheld electronic device 120. The function of the temporary memory unit 124 is for temporarily storing the original source code of the handheld electronic device 120 when the firmware of the handheld electronic device 120 is being upgraded. The purpose of this temporary storage is to backup a normal source code of the handheld electronic device 120 in case the handheld electronic device 120 fails to upgrade successfully. Should the handheld electronic device 120 encounters such problem, the original source code of the handheld electronic device 120 can be stored back to the storage unit 123 such that the user can still use the handheld electronic device 120 normally. In the preferred embodiment of the present invention, the temporary storage unit 124 can be a SDRAM or any other memory unit providing similar functions.

In another embodiment of the present invention, the handheld electronic device 120 further includes a display unit 125 and an input unit 126. The message that the display unit 125 of the handheld electronic device 120 can display includes an incoming call display, a message display, a multimedia file display, etc. In the embodiment of the present invention, when the transmitter 121 of the handheld electronic device 120 receives the upgrade program from the base station 110, the display unit 125 can inquire the user whether to execute the upgrade by a text or an image display. After the user sees the upgrade message displayed, the user can use the input unit 126 to manually decide whether to execute the upgrade immediately. The input unit 126 can be the keypad (not shown) on the handheld electronic device 120 or any other input unit that can input user command to the handheld electronic device 120.

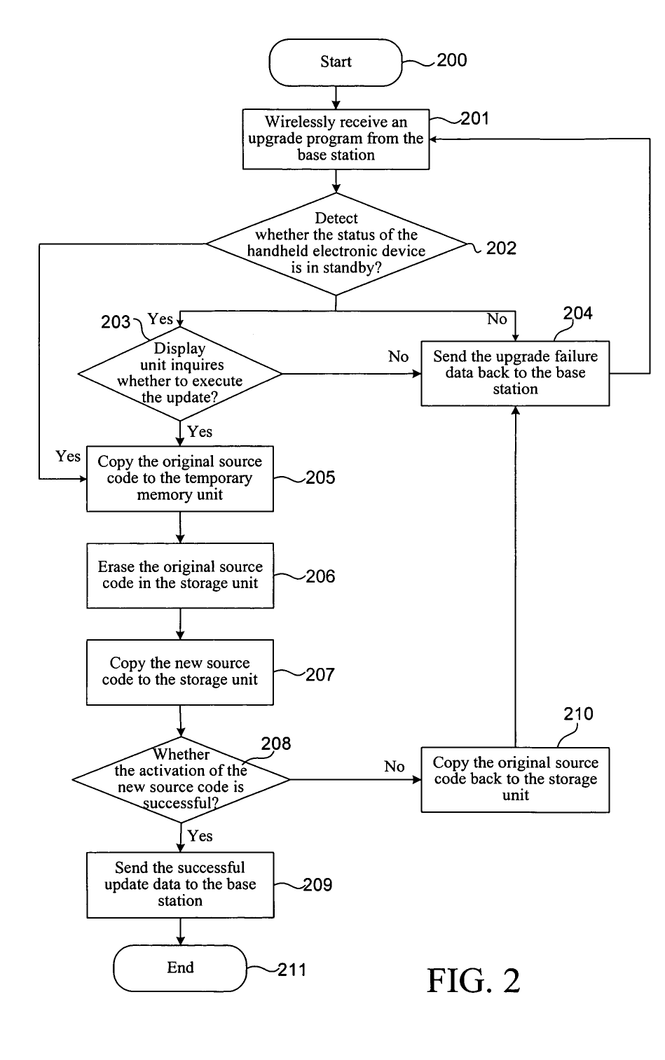

FIG. 2 shows in details the method for upgrading a firmware in a handheld electronic device 120 through a wireless transmission by a base station 110. The handheld electronic device 120 includes a transmitter 121 that is used to connect to a mobile telecommunication network 100.

In one embodiment of the present invention, the handheld electronic device 120 automatically executes the upgrade after receiving an upgrade program. First, in step 201, the transmitter 121 of the handheld electronic device 120 receives an upgrade program including an upgrade check code from the base station 110 via the wireless connection. Then, in step 202, the processing unit 121 of the handheld electronic device 120 detects whether the handheld electronic device 120 is in a standby status. If the processing unit 121 determines that the handheld electronic device 120 is in a standby status, then in step 205, an original source code is copied to a temporary memory unit 124 for backup. Then, in step 206, the original source code stored in the storage unit 123 is erased such that a storage space is provided in the storage unit 123. Then, in step 207, the new source code received is stored in the storage unit 123. After storing is complete, a display unit 124 can display a message requesting the user to restart the handheld electronic device 120. The restart operation will activate the new source code in step 208.

During the automatic upgrade process, if the processing unit 122 determines that the handheld electronic device 120 is in a power-off status or a power-on status but in use, then the present invention proceeds to step 204. A data of upgrade failure is sent to the manufacturer of the handheld electronic device 120 automatically via the wireless connection to the base station 110.

In another embodiment of the present invention, the upgrade procedure is manually executed after the handheld electronic device 120 receives the upgrade program. First, in step 201, the transmitter 121 of the handheld electronic device 120 receives an upgrade program including an upgrade check code from the base station 110 via the wireless connection. Then, in step 202, the processing unit 122 of the handheld electronic device 120 detects whether the handheld electronic device 120 is in a standby status. If the processing unit 122 determines that the handheld electronic device 120 is in a standby status, then in step 203, the display unit 125 inquires whether the user would like to proceed with the upgrade. At this time, the user can select whether to proceed with the firmware upgrade for the handheld electronic device 120 by an input unit 126.

If the user selects to proceed with the upgrade, then in step 205, an original source code is copied to a temporary memory unit 124 for backup. Then, in step 206, the original source code stored in the storage unit 123 is erased such that a storage space is provided in the storage unit 123. Then, in step 207, the new source code received is stored in the storage unit 123. After storing is complete, a display unit 125 can display a message requesting the user to restart the handheld electronic device 120. The restart operation will activate the new source code in step 208.

If the upgrade program is successfully upgraded to the handheld electronic device 120, namely the handheld electronic device 120 can normally operate the function upgraded, then in step 209, a data of successful upgrade is sent to the manufacturer of the handheld electronic device 120 through the wireless connection to the base station 110. Based on the successful upgrade data, the manufacturer of the handheld electronic device 120 is certain that the upgrade is complete. If the upgrade program cannot successfully be upgraded to the handheld electronic device 120, then in step 210, a data of upgrade failure is returned to the manufacturer of the handheld electronic device 120 through the transmitter wirelessly connecting to the base station 110.

Based on the upgrade failure data, the manufacturer of the handheld electronic device 120 is notified that the firmware of the handheld electronic device 120 is not yet completed with the upgrade. The manufacturer of the handheld electronic device 120 can try to resend an upgrade message to the user until an upgrade successful message returned from the handheld electronic device 120 is received. After a number of times of failure to upgrade wirelessly, the manufacturer of the handheld electronic device 120 can send a message to notify the user to return the handheld electronic device 120 back for firmware upgrade using the convention method.

Besides the above mentioned method for firmware upgrade by the manufacturer, the user can also actively proceed with the firmware upgrade as follows:

The user can send an upgrade request message to the base station 110 using the handheld electronic device 120. When the base station 110 identifies the firmware upgrade request from the user, the firmware upgrade will proceed as the embodiments mentioned above.

By means of the detailed descriptions of what is presently considered to be the most practical and preferred embodiments of the subject invention, it is believed that the features and the gist thereof have been clearly described. Nevertheless, these embodiments are not intended to be construed in a limiting sense. Instead, it will be well understood that any analogous variations and equivalent arrangements will fall within the spirit and scope of the invention.

1. A handheld electronic device, connecting to a base station via a mobile telecommunication network, an upgrade program being wirelessly transmitted from said base station to upgrade a firmware of said handheld electronic device, wherein said upgrade program having an upgrade check code and a new source code, said handheld electronic device comprising:
a transmitter for receiving the upgrade check code from said base station;
a storage unit for storing an original source code and a basic control code for controlling an upgrade operation; and
a processing unit for reading said basic control code after verifying said upgrade check code so as to replace said original source code with said new source code to store said new source code in said storage unit and complete said upgrade operation of said firmware.

2. The handheld electronic device of claim 1, wherein said processing unit automatically upgrades said firmware.

3. The handheld electronic device of claim 1, further comprising a display unit for inquiring a user whether to execute said upgrade operation.

4. The handheld electronic device of claim 1, further comprising an input unit allowing a user to input whether to execute said upgrade operation.

5. The handheld electronic device of claim 1, further comprising an input unit allowing a user to submit an upgrade request so as to request said base station to send out said upgrade program.

6. The handheld electronic device of claim 1, further comprising a temporary memory unit for temporarily storing said original source code when said handheld electronic device is being upgraded.

7. A method for upgrading a firmware of a handheld electronic device from a base station via a wireless transmission, said handheld electronic device having a transmitter, a processing unit, and a storage unit, and connecting to said transmitter via a mobile telecommunication network, wherein said storage unit is used for storing a source code and a basic control code, said method comprising the steps of:
wirelessly receiving an upgrade check code and a new source code from said base station;
verifying said upgrade check code by said processing unit; and
upgrading said firmware by the step of storing said new source code in said storage unit based on said basic control code.

8. The method of claim 7, said handheld electronic device comprising a temporary memory unit, wherein said upgrading step further comprising copying said original source code stored in said storage unit originally to said temporary memory unit.

9. The method of claim 8, wherein said upgrading step further comprising erasing said original source code in said storage unit.

10. The method of claim 8, wherein said storing step further comprising copying said new source code to said storage unit.

11. The method of claim 7, further comprising detecting a status of said handheld electronic device, when said status being a standby status, automatically executing said upgrading step.

12. The method of claim 11, further comprising displaying a message for inquiring a user whether to execute said upgrading step.

13. The method of claim 7, further comprising sending a data to said base station.

14. The method of claim 13, wherein when said data is a data of upgrade failure, said storing step further comprising copying said original source code in said temporary memory unit to said storage unit.
